(19) United States
(12) Patent Application Publication
(10) Pub. No.: US 2019/0087739 A1
(43) Pub. Date: Mar. 21, 2019

(54) LINEAR MODEL TO PREDICT LISTENER PREFERENCE RATINGS OF HEADPHONES

(71) Applicant: HARMAN INTERNATIONAL INDUSTRIES, INCORPORATED, Stamford, CT (US)

(72) Inventors: Sean E. OLIVE, Oak Park, CA (US); Todd S. WELTI, Thousand Oaks, CA (US); Omid KHONSARIPOUR, Northridge, CA (US)

(21) Appl. No.: 16/131,576

(22) Filed: Sep. 14, 2018

Related U.S. Application Data
(60) Provisional application No. 62/559,011, filed on Sep. 15, 2017.

(51) Int. Cl. G06N 5/04; G06F 17/50

(52) U.S. Cl. CPC G06N 5/048; G06F 2217/16; G06F 17/5009

(57) ABSTRACT

A headphone response error curve (HREC) may be calculated based on a difference in response between a headphone response curve for a headphone to be evaluated and a target headphone response curve. A linear model may be applied to the headphone response curve to determine a preference rating predicting overall sound quality of the headphone. The linear model may be developed using independent variables such as mean error (ME) of the headphones response curve to the target response curve, standard deviation (SD) of error of the HREC, or absolute value of a slope (AS) of a logarithmic regression line of the HREC.

### CROSS-REFERENCE TO RELATED APPLICATION

This application claims the benefit of U.S. provisional application Ser. No. 62/559,011 filed Sep. 15, 2017, the disclosure of which is hereby incorporated in its entirety by reference herein.

### TECHNICAL FIELD

Aspects of the disclosure generally relate to subjective and objective measurements of headphones, and more specifically to a linear model to predict listener preference ratings of the headphones.

### SUMMARY

In one or more illustrative examples, a system for predicting listener preference ratings for headphones includes a memory storing a linear model predicting a preference rating for headphones; and a processor. The processor is programmed to receive a headphone response curve defining a frequency response of a headphone, apply the linear model to the headphone response curve to determine a preference rating, and utilize the preference rating to predict overall sound quality of the headphone without listening tests.

In one or more illustrative examples, a method for predicting listener preference ratings for headphones includes calculating a headphone response error curve (HREC) based on a difference in response between a headphone response curve for a headphone to be evaluated and a target headphone response curve. The method further includes applying a linear model to the headphone response curve to determine a preference rating predicting overall sound quality of the headphone, the linear model being developed using independent variables including mean error (ME) of the headphones response curve to the target response curve, standard deviation (SD) of error of the HREC, and absolute value of the slope (AS) of a logarithmic regression line of the HREC.

In one or more illustrative examples, non-transitory computer-readable medium includes instructions that, when executed by one or more processors of a computing device, cause the computing device to measure a left and right channel response of a headphone using a headphone coupler device; compute a headphone response curve from magnitude response of the left and right channels; calculate a headphone response error curve (HREC) based on a difference in response between a headphone response curve for a headphone to be evaluated and a target headphone response curve; and apply a linear model to the headphone response curve to determine a preference rating predicting overall sound quality of the headphone.

### BRIEF DESCRIPTION OF THE DRAWINGS

FIG. 1 illustrates an example system for a computing device configured to perform headphone listening tests;

FIG. 2 illustrates an example system for the computing device configured to perform measurements for predicted headphone listening ratings;

FIG. 3 illustrates an example of three graphs of headphone measurements in comparison to a target headphone response curve;

FIG. 4 illustrates an example scatterplot showing measured versus predicted preference ratings for a set of headphones;

FIG. 5 illustrates example plots of results of an outlier analysis to determine which headphone models are not well explained by the model in terms of the independent variables and the preference rating; and

FIG. 6 illustrates an example process for predicting listener preference ratings for headphones.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

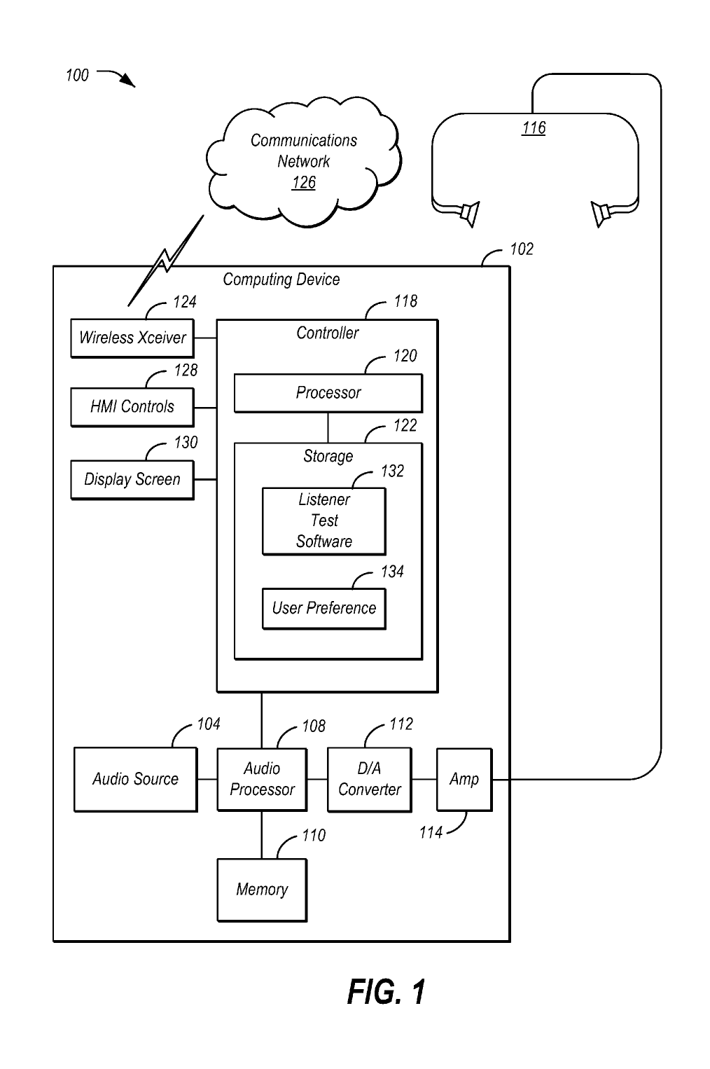

FIG. 1 illustrates an example system 100 for a computing device 102 configured to perform headphone listening tests. The computing device 102 selects audio via an audio source 104 or an audio input, and passes the audio to be processed to an audio processor 108. Audio output from the audio processor 108 may be passed through a digital to analog (D/A) converter 112 and an amplifier 114 for reproduction by replicator headphones 116. The computing device 102 also includes a controller 118 connected to the audio processor 108 and configured to manage the performance of the virtual headphone listening tests via listener test software 132. The controller 118 determines an audio source to play back and a headphone to simulate, and directs the audio processor 108 to process the audio to conform to that of the simulated headphone. The controller 118 also interfaces with a wireless transceiver 124 to facilitate communication over a communications network 126, so as to provide the results to a remote server. In many examples, the controller 118 is also connected to one or more human machine interface (HMI) controls 128 to receive user input, as well as a display screen 130 to provide visual output. It should be noted that the illustrated system 100 is merely an example, and more, fewer, and/or differently located elements may be used.

The audio source 104 may be a recording such as a music program that may be used in the headphone tests. In an example, the audio source 104 may include one or more stereo tracks that were digitally copied from a compact disc and edited into brief 10-20 second loops. In some examples, the audio source 104 may be analog instead of digital, and in such cases the system may further include an analog-to-digital (A/D) converter 106 that converts signals from an analog format into a digital format for further processing by the audio processor 108.

While only one is shown, one or more audio processors 108 may be included in the computing device 102. The audio processors 108 may be one or more computing devices capable of processing audio and/or video signals, such as a computer processor, microprocessor, a digital signal processor, or any other device, series of devices, or other mechanisms capable of performing logical operations. The audio processors 108 may operate in association with a memory 110 to execute instructions stored in the memory 110. The instructions may be in the form of software, firmware, computer code, or some combination thereof, and when executed by the audio processors 108 may provide for headphone virtualization functionality. The memory 110 may be any form of one or more data storage devices, such as volatile memory, non-volatile memory, electronic memory, magnetic memory, optical memory, or any other form of data storage device. In addition to instructions, operational parameters and data may also be stored in the memory 110.

The D/A converter 112 receives the digital output signal from the audio processor 108 and converts it from a digital format to an output signal in an analog format. The output signal may then be made available for use by the amplifier 114 or other analog components for further processing.

The amplifier 114 may be any circuit or standalone device that receives audio input signals of relatively small magnitude, and outputs similar audio signals of relatively larger magnitude. Audio input signals may be received by the amplifier 114 and output on one or more connections to the replicator headphones 116. The amplifier 114 may include capability to adjust volume, balance, and/or fade of the audio signals provided to the replicator headphones 116. In still other examples, the replicator headphones 116 may include the amplifier 114, such that the replicator headphones 116 are self-powered.

The replicator headphones 116 may be a standardized pair of headphones with known frequency response characteristics. The replicator headphones 116 may be equalized through use of the audio processor 108 to provide a measured magnitude response and/or other characteristics of a headphone model to be simulated. The headphone model to be simulated may be a specific model of headphones whose response was previously characterized, e.g., though use of frequency response measurements of the headphone. As another possibility, the headphone model to be simulated may be an unreleased test headphone model, a hypothetical headphone having an In-Ear (IE) target response curve, or a hypothetical headphone having an Around-the-Ear (AE) or Over-the-Ear (OE) target response curve. In a majority of cases, headphones with measurements consistent with the IE/AE/OE target response may be rated higher by listeners than headphones with measurements that deviate from the IE/AE/OE target response.

The controller 118 may include various types of computing apparatus in support of performance of the functions of the computing device 102 described herein. In an example, the controller 118 may include one or more processors 120 configured to execute computer instructions, and a storage medium 122 on which the computer-executable instructions and/or data may be maintained. A computer-readable storage medium (also referred to as a processor-readable medium or storage 122) includes any non-transitory (e.g., tangible) medium that participates in providing data (e.g., instructions) that may be read by a computer (e.g., by the processor(s) 120). In general, a processor 120 receives instructions and/or data, e.g., from the storage 122, etc., to a memory and executes the instructions using the data, thereby performing one or more processes, including one or more of the processes described herein. Computer-executable instructions may be compiled or interpreted from computer programs created using a variety of programming languages and/or technologies including, without limitation, and either alone or in combination, JAVA, C, C++, C#, ASSEMBLY, FORTRAN, PASCAL, VISUAL BASIC, PYTHON, JAVA SCRIPT, PERL, PL/SQL, ETC.

As shown, the controller 118 may include a wireless transceiver 124 or other network hardware configured to facilitate communication between the controller 118 and other networked devices over the communications network 126. As one possibility, the wireless transceiver 124 may be a cellular network transceiver configured to communicate data over a cellular telephone network. As another possibility, the wireless transceiver 124 may be a Wi-Fi transceiver configured to connect to a local-area wireless network to access the communications network 126.

The controller 118 may receive input from human-machine interface (HMI) controls 128 to provide for user interaction with computing device 102. For instance, the controller 118 may interface with one or more buttons or other HMI controls 128 configured to invoke functions of the controller 118. The controller 118 may also drive or otherwise communicate with one or more displays 130 configured to provide visual output to users, e.g., by way of a video controller. In some cases, the display 130 may be a touch screen further configured to receive user touch input via the video controller, while in other cases the display 130 may be a display only, without touch input capabilities.

In an example, the display 130 may be utilized to present a screen of the listener test software 132. The listener test software 132 may administers the test, implements the finite input response (FIR) filters for the virtual headphones, and collects the listeners' ratings. The interface displayed to the display 130 may be used by the listener to randomly switch among the different virtualized headphones and rate them. The listener test software 132 may be further configured to provide for storage and analysis of the listeners' ratings. The listener's ratings may be compiled by the listener test software 132 into user preferences 134 that indicate which headphones are more or less preferred by the user. For instance, the user preferences 134 may include scores along a range, e.g., 0-9, 1-100, where an increasing score indicates a greater relative preference. Examples of the recorded ratings and analysis performed to the ratings are described in detail herein.

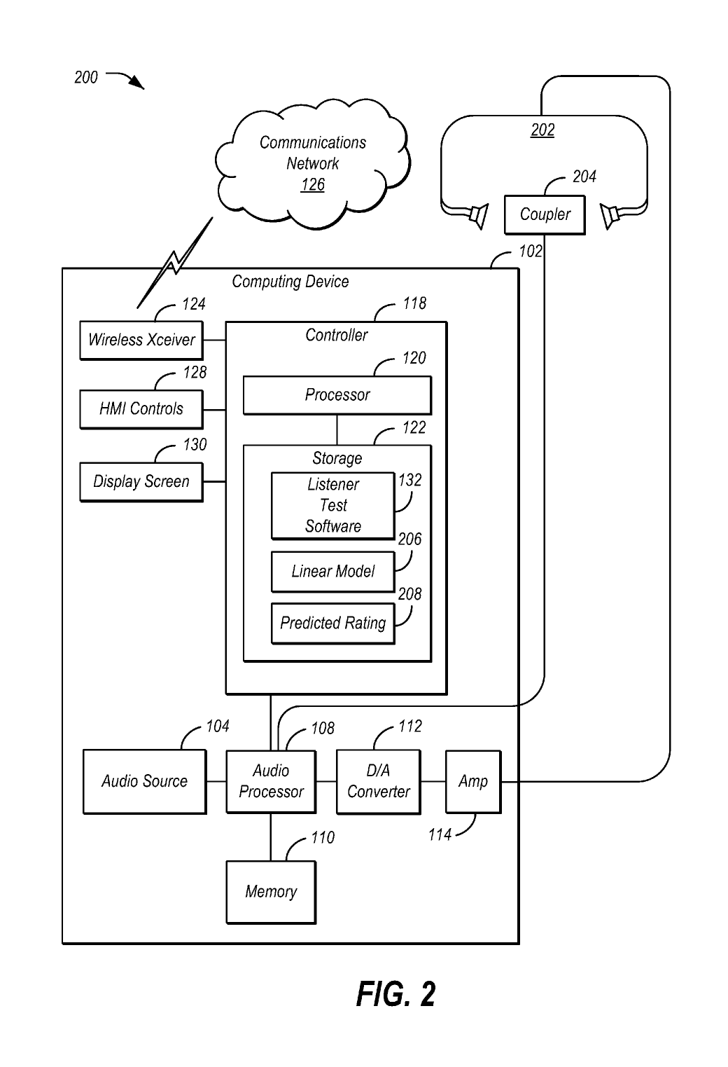

FIG. 2 illustrates an example system 200 for the computing device 102 configured to perform measurements for predicted headphone listening ratings. As compared to the system 100, the listener test software 132 in the system 200 may be further programmed to utilize a statistical model to predict preference ratings 208 of various types of headphones (e.g., IE, AE/OE, etc.), without requiring user input from listener tests. Using the model, the predicted preference ratings 208 may eliminate the need to conduct time-consuming and expensive listening tests to validate headphone designs, which may save time and money. Moreover, using the model, objective performance targets can be created that establish consistent headphone design goals for each brand.

Instead of using a replicator headphone 116 as shown in the system 100, the system 200 includes a headphone 202 under test. The headphone 202 may be a headphone device of unknown characteristics. The headphone 202 may be connected to a headphone coupler 204. In one example, the headphone coupler 204 may be a standard IEC 711 coupler. The headphone coupler 204 may be utilized by the computing device 102 to measure the response of the headphone 202 in comparison to audio input provided by the computing device 102 via the audio processor 108.

In an example, for a new headphone 202 to be tested, the headphone coupler 204 may be utilized to measure frequency response of the left and right channels of the headphone 202, e.g., from 20 Hz to 20 kHz in 48 log spaced points from 20 Hz to 20 kHz. This information may be recorded by the audio processor 108. The listener test software 132 may be programmed to receive the recorded frequency response information and calculate an average magnitude response of the left and right channels.

The listener test software 132 may be further programmed to calculate a headphone response error curve (HREC) based on a difference in response between the headphone 202 and a target headphone response curve. In many examples, the HREC is only calculated for frequencies between 20 Hz to 10 kHz, since above 12 kHz there are error variances in the ear simulators and ear canals of listeners related to anthropometric differences that are not included in HREC and the linear model 206 (discussed in more detail below).

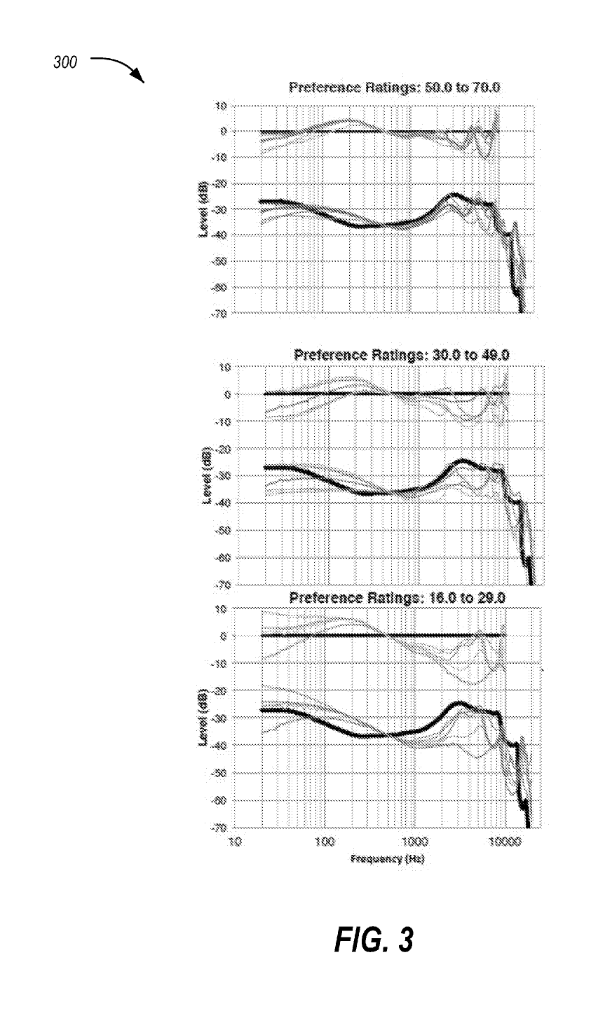

The target headphone response curve may be a response curve for a hypothetical headphone. The target headphone response curve may indicate a desired response curve for headphones generally. (An example target headphone response curve is shown in FIG. 3, discussed below.) In an example, the target headphone response curve may be found experimentally. In some cases, different target response curves may be used for IE headphones as opposed to around-the-ear (AE) headphones. For instance, the preferred target response for an IE headphone may be similar to the preferred AE target response, but with an additional 4 dB bass and some differences above 1 KHz. A possible reason for listeners preferring more bass in IE headphones is to compensate for increased physiological noise from the occlusion effect.

FIG. 3 illustrates an example 300 of three graphs of headphone measurements in comparison to a target headphone response curve. The first of the three graphs shows headphone measurements where the headphones received high preference ratings (50-70 points), the second of the graphs shows headphone measurements where the headphones received mediocre preference ratings (30-49 points), while the third of the graphs shows headphone measurements where the headphones received low preference ratings (16-29 points). In each graph, the HREC's are shown at the top of the graph with the magnitude responses of the headphones plotted below with a preferred IE headphone target response curve plotted as a thick black curve.

A trend can be seen from the graphs 300 that headphones receive lower preference ratings as their response deviates further away from the response of the target curve. Accordingly, the HREC may serve as a primary metric to explain and predict a preference rating for a headphone 202.

As described herein, a statistical model can be developed using a selection of independent variables derived from statistical measures of the error response curve of the headphones to be considered. Several independent variables may be considered as potential candidates for a model as being derived from the error response curve of the headphone 202. These may include different statistical measures of the errors including the mean error, the standard deviation of the error, and the slope of the error curve. As some further examples, the independent variables may include one or more of the bandwidth over which the errors occurred to possibly account for the frequency-dependent sensitivity and selectivity of human hearing, as well as possible frequency-dependent interactions between the headphones and spectra of the program material. In situations where there are limited significant program effects or interactions with headphones, it follows that such a situation would be unlikely to account for possible bandwidth effects.

As discussed herein, while other variables may be used, an example set of measures utilized in generation of the model 206 includes mean error, standard deviation of the error, and slope of the error curve. The model may further consider frequency range or bandwidth over which the errors occurred. The listener test software 132 may utilize a linear model 206 developed using these or other independent variables as discussed in detail herein. Also, as discussed herein, such a linear model 206 based on the mean error, standard deviation, and slope of the headphone's error response curve can accurately predict the headphone's preference rating with an error of 5.5% and a correlation coefficient of r=0.91. After some preliminary regression and principal component analysis of these different independent variables, the following three explanatory variables may be relatively useful for the predictive linear model 206 when applied to IE headphones:
ME_{40 Hz}_{_}_{10 kHz}—The mean error defined by the headphone response error curve calculated by the absolute value of the y-values from 40 Hz to 10 kHz as expressed in equation 1.

$${ME}_{40 Hz - 10 kHz} = \frac{abs ( y 1 ) + abs ( y 2 ) + abs ( y 3 )}{n} \qquad ( 1 )$$

SD—The standard deviation of the error defined by the headphone error curve calculated from the y-values from 20 Hz to 10 kHz as defined in equation 2.

$$SD = \frac{\sqrt{\sum {( y - \overline{y} )}^{2}}}{( n - 1 )} \qquad ( 2 )$$

AS—The absolute value of the slope of a logarithmic regression line that best fits the y and x values defined in the headphone error response curve from 20 Hz to 10 kHz.

$$AS = \sqrt{\frac{\sum ( ln ( x ) - ln ( \overline{x} ) ) ( y - \overline{y} )}{\sum ( ln ( x ) - {ln ( \overline{x} )}^{2}}} \qquad ( 3 )$$

Regarding the linear model 206 used to predict a preference rating of the headphones 202, the linear model 206 was developed using the three independent variables discussed in the previous section. The regression was performed using Partial Least Squares (PLS) due to the collinear nature of the independent variables. PLS reduces the independent variables to a set of uncorrelated principal components, and then performs least squares regression. PLS regression is appropriate when the predictors are highly collinear, and/or when there are more predictors than observations and ordinary least-squares regression either produces coefficients with high standard errors or fails completely.

After a reiterative process, a linear model 206 expressed in Equation 4 was found to produce the best goodness of fit (see Table 1 below) based on the Pearson correlation coefficient (r=0.91) and the lowest root mean squares error (MSE) of 5.5%. The latter represents an error of 5.5 points on the 100-point preference scale, and smaller than the error in the subjective preference ratings. Table 1 illustrates statistics regarding the goodness of fit for the linear model 206 utilizing the Equation 4.

Pred. Preference=68.685−(3.238*SD)−(4.473*AS)−(2.658*ME) (4)

TABLE 1
The Goodness of Fit Statistics for
the IE predictive linear model 206

| | |
|---|---|
| Observations | 32.000 |
| Sum of weights | 31.000 |
| DF | 29.000 |
| R | 0.91 |
| R² | 0.819 |
| Standard deviation | 5.691 |
| MSE | 30.301 |
| RMSE | 5.505 |

Similar techniques may be applied to AE/OE headphones. For AE/OE headphones, the same three variables defined in equations (1), (2), and (3) may be initially selected to provide different statistical measures of deviations in the error response curves. A linear model for AE/OE headphones may then be developed initially using these independent variables. A regression analysis may similarly be performed using Partial Least Squares (PLS) due to the collinear nature of the explanatory variables. After an iterative process, a linear model for AE/OE headphones was found that produces the best goodness of fit based on the Pearson correlation coefficient of r=0.86. The statistics for goodness of fit are summarized in Table 2 and the equation for the AE/OE model is defined in equation (5):

Pred. Preference=114.49−(12.62*SD)−(15.52*AS) (5)

TABLE 2
The Goodness of Fit Statistics for the
AE/OE predictive linear model 206

| | |
|---|---|
| Observations | 32.000 |
| Sum of weights | 31.000 |
| DF | 29.000 |
| R | 0.741 |
| R² | 0.861 |
| Standard deviation | 6.933 |
| MSE | 44.962 |
| RMSE | 6.705 |

The standardized coefficients for the variables in the model are weighted approximately equal: SD=−0.47, and AS=−0.434. Note that the model for AE/OE headphones only has two independent variables (i.e., SD and AS) since including the third variable ME added little information to explaining the variance in preference ratings, and reduced the quality of the model.

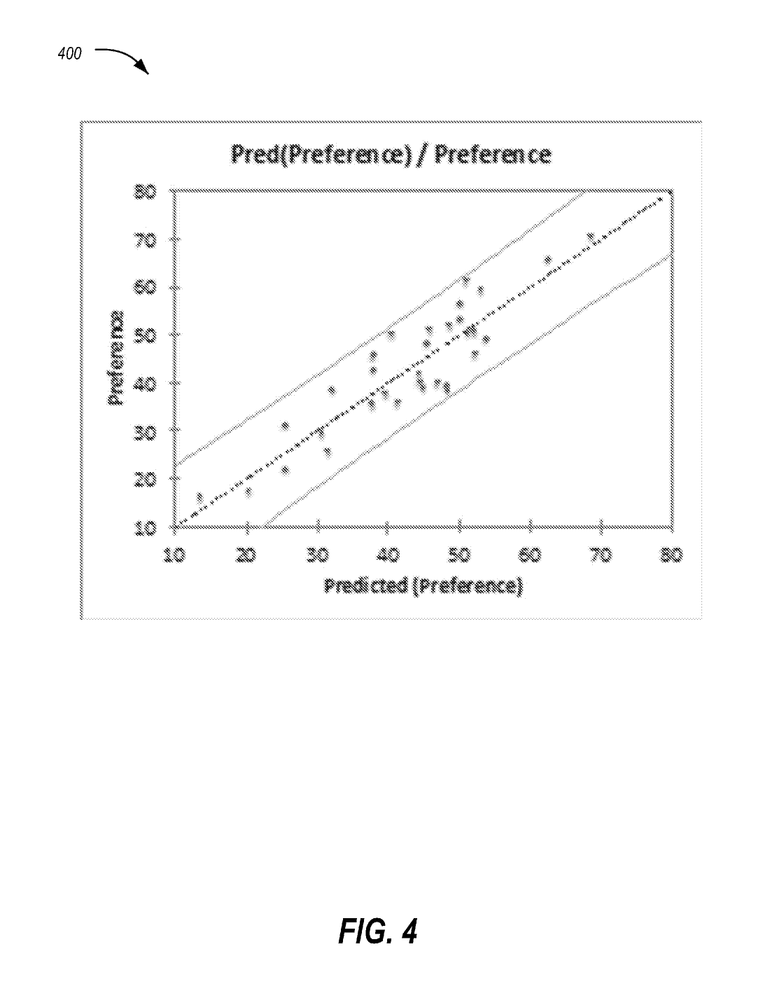

FIG. 4 illustrates an example scatterplot 400 of predicted ratings 208 versus measured preference ratings of various different IE headphones. As shown, the scatterplot 400 includes measured versus predicted preference ratings for 32 different IE headphones 202. The standardized coefficients for the three independent variables are: SD=0.338, AS=−0.303, and ME=−0.324, which indicates that each variable is weighted approximately the same in the example. In an example, the measured preference ratings are taken from five controlled listening tests based on 71 trained and untrained listeners. Also, shown are the upper and lower 95% confidence intervals, meaning that there is only a 5% chance that the predicted ratings fall outside these confidence limits.

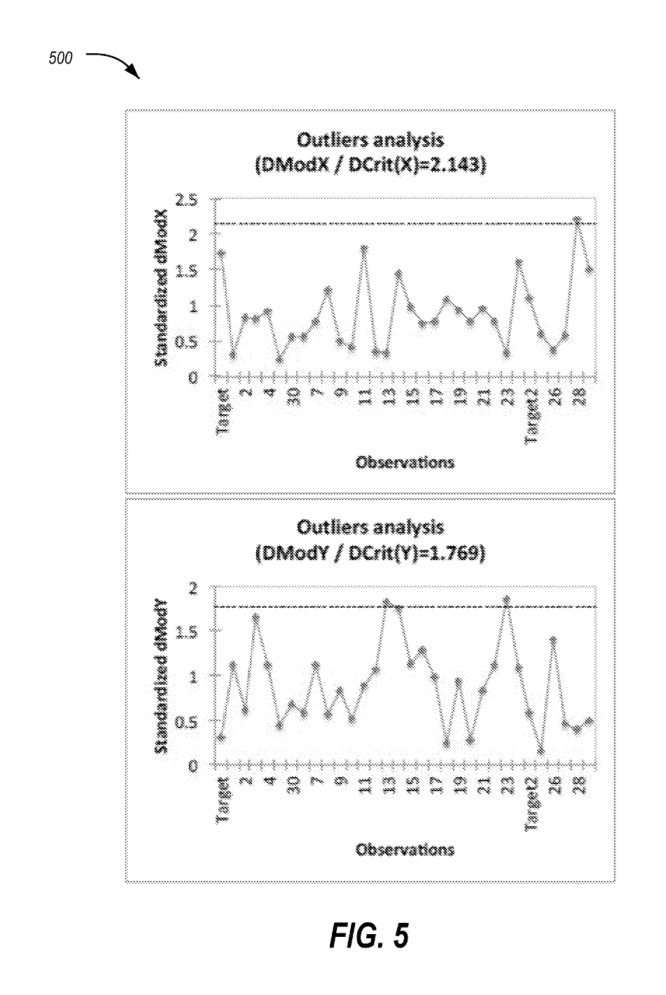

FIG. 5 illustrates example plots 500 of results of an outlier analysis to determine which headphone models are not well explained by the model in terms of the independent variables and the preference rating. The first graph shows the distances of each observation to the model in the space of the x variables, identifying the outliers for the explanatory variables, while the second graph shows the distances of each observation to the model in the space of the y variables for the model defined by Equation 4. It can be seen from the graphs that observation 28 (headphone 28) is an outlier. The second graph shows the same information in the space of the y variable identifying outliers for the dependent variables (i.e., the preference rating). Notably, in the second graph the headphones 13 and 23 are both outliers.

Regarding validation of the model 206, the model 206 may be validated in various ways, two of which are discussed herein. In one example, model 206 may be validated by applying it to each of a set of listening tests performed using the headphones 202, and in another example by randomly removing a subset of headphones 202 from the original sample of headphones, recalculating the model 206 using the explanatory variables, and then applying the recalculated model 206 to the entire headphone 202 sample. This second approach may be repeated multiple times (e.g., 10 times in this example) after randomly removing a subset of the headphones 202 (in this example first six headphones 202 and then ten headphones 202 from the total sample).

Table 3 shows the Pearson correlation coefficient r, and the RMSE for each of the five listening tests reported in [1]. The statistics indicate that the model provides consistently accurate predictions with low errors across all five tests, suggesting that it is not too over-fitted.

TABLE 3
Goodness of fit statistics for model applied
to the results from five listening tests

| Test | Correlation Coefficient r | RMSE |
|---|---|---|
| One | 0.96 | 4.95 |
| Two | 0.95 | 5.58 |
| Three | 0.89 | 6.35 |
| Four | 0.90 | 5.46 |
| Five | 0.98 | 3.81 |
| Six | 0.96 | 4.95 |

Table 4 shows the goodness of fit statistics for the second validation test where either 6 or 10 headphones were removed from the original sample of 29 headphones after which the model was recalculated and applied to the entire sample.

TABLE 4
Goodness of Fit Statistics for Validation of Model

| Number of Headphones | Range of | Mean | Range of | Mean |
|---|---|---|---|---|
| in Subset | r value | r value | RSME value | RSME |
| 6 | 0.87-0.96 | 0.91 | 4.4-6.1 | 5.5 |
| 10 | 0.83-0.95 | 0.90 | 4.4-6.1 | 5.5 |

While removing six versus ten headphones 202 from the sample produced slightly better predictions of headphone preferences, both produced relatively good predictions and low error when averaged over 10 validation tests. Thus, the model 206 seems to be relatively robust when applied to different subsets of headphones 202 from the sample.

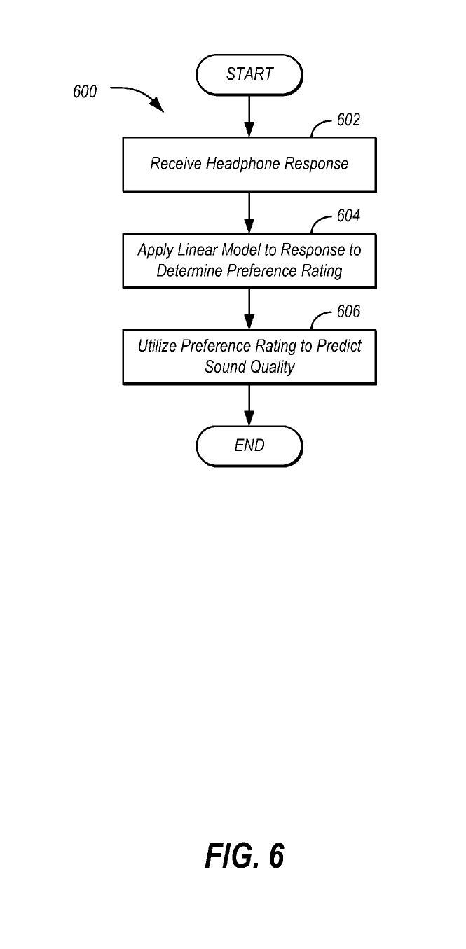

FIG. 6 illustrates an example process 600 for predicting listener preference ratings 208 for headphones. In an example, the process 600 may be performed using the computing device 102 of FIG. 1.

At 602, the computing device 102 receives a headphone response curve defining a frequency response of a headphone. In an example, for a new headphone 202 to be tested, frequency response of the left and right channels of the headphone are measured by the computing device 102 using the coupler 204, e.g., from 20 Hz to 20 kHz in 48 log spaced points from 20 Hz to 20 kHz. An average magnitude response of the left and right channels may then be calculated. (In some examples, the exact number of points per octave (known as the frequency resolution) could be reduced, if necessary, or smoothed down to 1/12-octave to reduce data storage requirements or to better simulate frequency resolution of human perception.) A headphone response error curve (HREC) may then be calculated by the computing device 102 based on a difference in response between the headphone being tested and a target headphone response curve.

At 604, the computing device 102 applies the linear model 206 to the headphone response curve to determine a preference rating 208. In an example, three independent variables are calculated by the computing device 102 from the error response curve: the Mean Error (ME), the standard deviation (SD) and the absolute value of the Slope (AS), which is the slope of a logarithmic regression line that best fits the x and y values of the error response curve. The ME may be calculated from 40 Hz to 10 kHz. the SD and AS may be calculated from 20 Hz to 10 kHz. As shown in Equation 4, the predicted preference rating 208 of the headphone may, accordingly, be calculated using the linear regression model 206 where the three variables are weighted. Equation 5 shows an alternate example for a predicted preference rating 208 for AE/OE headphones, that uses only two of the variables.

At 606, the computing device 102 utilizes the preference rating 208 to predict overall sound quality of the in-ear headphone without listening tests. Accordingly, this system and method can be implemented as an algorithm included in the listener test software 132. The listener test software 132 may automatically calculate the sound quality or preference rating 208 after the measurement is performed. The listener test software 132 may, therefore, be used to make headphone design and testing more efficient and cost effective since the predicted preference rating 208 may largely eliminate the cost and time required to conduct controlled listening tests.

While an exemplary modularization of the computing device 102 is described herein, it should also be noted that elements of the computing device 102 may be incorporated into fewer units or may be combined in several units or even in one unit.

Computing devices described herein generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, JAVA™, C, C++, VISUAL BASIC, JAVA SCRIPT, PERL, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for predicting listener preference ratings for headphones comprising:
a memory storing a linear model predicting a preference rating for headphones; and
a processor programmed to
receive a headphone response curve defining a frequency response of a headphone,
apply the linear model to the headphone response curve to determine a preference rating, and
utilize the preference rating to predict overall sound quality of the headphone without listening tests.

2. The system of claim 1, wherein the system further comprises a headphone coupler configured to measure the headphone response curve.

3. The system of claim 1, wherein the processor is further programmed to calculate a headphone response error curve (HREC) based on a difference in response between the headphone response curve and a target headphone response curve.

4. The system of claim 3 wherein the headphone response curve is computed as an average magnitude response of left and right channels of the headphone.

5. The system of claim 3 wherein the headphone is an in-ear headphone, and the target headphone response curve is a target response specific to in-ear headphones.

6. The system of claim 3, wherein the linear model is developed using independent variables including mean error (ME) of the headphones response curve to the target headphone response curve, standard deviation (SD) of error of the HREC, and absolute value of a slope (AS) of a logarithmic regression line that best fits y and x values defined in the HREC.

7. The system of claim 6, wherein the ME, SD, and AS independent variables are weighted equally in the linear model.

8. The system of claim 6, wherein the SD, and AS independent variables are weighted equally in the linear model and the ME variable is not used.

9. The system of claim 6, wherein the ME is calculated from 40 Hz to 10 kHz, and the SD and AS are calculated from 20 Hz to 10 kHz.

10. A method for predicting listener preference ratings for headphones, comprising:
calculating a headphone response error curve (HREC) based on a difference in response between a headphone response curve for a headphone to be evaluated and a target headphone response curve; and
applying a linear model to the headphone response curve to determine a preference rating predicting overall sound quality of the headphone, the linear model being developed using independent variables including mean error (ME) of the headphones response curve to the target response curve, standard deviation (SD) of error of the HREC, and absolute value of a slope (AS) of a logarithmic regression line of the HREC.

11. The method of claim 10, wherein the ME is computed according to the equation:
$${ME}_{40 Hz - 10 kHz} = \frac{abs ( y 1 ) + abs ( y 2 ) + abs ( y 3 )}{n} .$$

12. The method of claim 10, wherein the SD is computing according to the equation:
$$SD = \frac{\sqrt{\sum {( y - \overline{y} )}^{2}}}{( n - 1 )} .$$

13. The method of claim 10, wherein the AS is computed according to the equation:
$$AS = \sqrt{\frac{\sum ( ln ( x ) - ln ( \overline{x} ) ) ( y - \overline{y} )}{\sum ( ln ( x ) - {ln ( \overline{x} )}^{2}}} .$$

14. The method of claim 10, further comprising developing the linear model using a Partial Least Squares (PLS) regression.

15. The method of claim 10, further comprising computing the headphone response curve as an average magnitude response of left and right channels of the headphone.

16. The method of claim 10, further comprising computing the headphone response curve of left and right channels of the headphone separately.

17. The method of claim 10, further comprising measuring the headphone response curve using a headphone coupler device.

18. A non-transitory computer-readable medium comprising instructions that, when executed by one or more processors of a computing device, cause the computing device to:
measure a left and right channel response of a headphone using a headphone coupler device;
compute a headphone response curve from magnitude response of the left and right channels;
calculate a headphone response error curve (HREC) based on a difference in response between a headphone response curve for a headphone to be evaluated and a target headphone response curve; and
apply a linear model to the headphone response curve to determine a preference rating predicting overall sound quality of the headphone.

19. The medium of claim 18, further comprising instructions that, when executed by one or more processors of a computing device, cause the computing device to develop the linear model using a Partial Least Squares (PLS) regression of independent variables including mean error (ME) of the headphones response curve to the target response curve, standard deviation (SD) of error of the HREC, and absolute value of a slope (AS) of a logarithmic regression line of the HREC.

20. The medium of claim 18, wherein the ME is calculated from 40 Hz to 10 kHz according to the equation
$${ME}_{40 Hz - 10 kHz} = \frac{abs ( y 1 ) + abs ( y 2 ) + abs ( y 3 )}{n} ;$$
the SD is calculated from 20 Hz to 10 kHz according to the equation
$$SD = \frac{\sqrt{\sum {( y - \overline{y} )}^{2}}}{( n - 1 )} ;$$
and
the AS is calculated from 20 Hz to 10 kHz according to the equation
$$AS = \sqrt{\frac{\sum ( ln ( x ) - ln ( \overline{x} ) ) ( y - \overline{y} )}{\sum ( ln ( x ) - {ln ( \overline{x} )}^{2}}} .$$
